(19) United States
(12) Patent Application Publication
(10) Pub. No.: US 2010/0208228 A1
(43) Pub. Date: Aug. 19, 2010

(54) EXPOSURE APPARATUS, EXPOSURE METHOD, AND DEVICE MANUFACTURING METHOD

(75) Inventors: Shinichiro Koga, Utsunomiya-shi (JP); Kazuhiko Mishima, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/707,461

(22) Filed: Feb. 17, 2010

(30) Foreign Application Priority Data
Feb. 19, 2009 (JP) 2009-036543

(51) Int. Cl. G03B 27/62

(52) U.S. Cl. 355/75; 355/77

(57) ABSTRACT

An exposure apparatus of the present invention is an exposure apparatus which exposes a pattern of an original plate 3 onto a substrate 5, and the exposure apparatus comprises an original plate alignment detection system 13 which moves the original plate 3 in an in-plane direction at an outside of an exposure region to measure positions of a plurality of alignment marks of the original plate 3, an interferometer 23 which measures a position of the original plate alignment detection system 13, a calculator which calculates a position and a shape of the original plate 3 from the positions of the plurality of alignment marks, and a correction unit which performs a correction in accordance with the position and the shape of the original plate 3 during exposure.

### BACKGROUND OF THE INVENTION

1. Field of the Invention

The present invention relates to an exposure apparatus which aligns an original plate with a substrate with high accuracy to expose a pattern on the original plate onto the substrate.

2. Description of the Related Art

Recently, along with the miniaturization and the high integration of a semiconductor integrated circuit such as an IC or an LSI or a liquid crystal panel, an exposure apparatus such as a semiconductor exposure apparatus is also provided with high accuracy and high functionality. Especially, when an alignment between an original plate such as a mask (a reticle) and a substrate such as a semiconductor substrate or a glass substrate is performed, a technology of overlapping the original plate with the substrate by nano order is required.

However, when the original plate absorbs exposure light to be thermally expanded, the overlapping accuracy between the original plate and the substrate is deteriorated. Because light intensity of the exposure used for the illumination in a constant time increases in accordance with improving the throughput of the exposure apparatus, the deterioration (error amount) of the overlapping accuracy gets larger. Therefore, a technology of measuring the deformation of the original plate and correcting the deformation during the exposure has been proposed. For example, Japanese Patent Laid-open Nos. 10-135119 and 2001-274080 disclose an exposure apparatus which measures a position displacement between a position measurement mark formed on an original plate and a reference mark on a member of the exposure apparatus to measure the deformation of the original plate.

However, in the measurement method disclosed in Japanese Patent Laid-open Nos. 10-135119 and 2001-274080, a position of a detection system for observing an original plate alignment mark is fixed, and the position of the measurable original plate alignment mark is limited. Even if the number of the detection system is increased, another reference mark is necessary when measuring the original plate alignment mark and reference marks need to be provided at a plurality of positions in order to measure a lot of positions on the original plate.

As a reference mark, a mark on a substrate stage which can be driven is also usable, but the substrate stage needs to be at a predetermined position during the measurement. Therefore, other processes using the substrate stage can not be performed during the measurement and the throughput is deteriorated. Because the mark described above is observed in the exposure region, a process such as an evacuation process where an observation system evacuates between at the time of observing the mark and at the time of exposure is required, and the throughput is deteriorated also in view of this.

### BRIEF SUMMARY OF THE INVENTION

The present invention provides an exposure apparatus capable of correcting a position and a shape of an original plate at high velocity and with high accuracy.

An exposure apparatus as one aspect of the present invention is an exposure apparatus which exposes a pattern of an original plate onto a substrate. The exposure apparatus comprises an original plate alignment detector configured to move the original plate in an in-plane direction at an outside of an exposure region to measure positions of a plurality of alignment marks of the original plate, a measurement unit configured to measure a position of the original plate alignment detector, a calculator configured to calculate a position and a shape of the original plate from the positions of the plurality of alignment marks, and a correction unit configured to perform a correction in accordance with the position and the shape of the original plate during exposure.

An exposure method as another aspect of the present invention is an exposure method of exposing a pattern of an original plate onto a substrate. The exposure method comprises the steps of moving the original plate alignment detector in an in-plane direction of the original plate at an outside of an exposure region to measure positions of a plurality of alignment marks formed on the original plate, measuring a position of the original plate alignment detector, calculating a position and a shape of the original plate from the positions of the plurality of alignment marks, and performing a correction in accordance with the position and the shape of the original plate during exposure.

A device manufacturing method as another aspect of the present invention comprises the steps of exposing a substrate using an exposure apparatus, and developing the exposed substrate.

Further features and aspects of the present invention will become apparent from the following description of exemplary embodiments with reference to the attached drawings.

### BRIEF DESCRIPTION OF THE DRAWINGS

FIG. 1 is a schematic diagram (side view) of an original plate alignment detection system and its surroundings in Embodiment 1.

FIG. 2 is a schematic diagram of an exposure apparatus in Embodiment 1.

FIG. 3 is a schematic diagram of an exposure station in Embodiment 1.

FIG. 4 is a schematic diagram of a measurement station in Embodiment 1.

FIG. 5 is a schematic diagram (plan view) of an original plate alignment detection system and its surroundings in Embodiment 1.

FIG. 6 is a schematic diagram showing one example of an original plate alignment scope in Embodiment 1.

FIG. 7 is a schematic diagram showing another example of an original plate alignment scope in Embodiment 1.

FIG. 8 is a schematic diagram (side view) of another original plate alignment detection system and its surroundings in Embodiment 1.

FIG. 9 is a flowchart of methods of measuring a shape and a position of an original plate and of correcting them in Embodiment 1.

FIG. 10 is a schematic diagram of an original plate which is provided with alignment marks in Embodiment 1.

FIG. 11 is a flowchart of an original plate alignment measuring step in Embodiment 1.

FIG. 12 is one example of an imaging order of original plate alignment marks in Embodiment 1.

FIG. 13 is one example of a configuration where alignment marks are arranged on an original plate and a reference plate in Embodiment 1.

FIG. 14 is a schematic diagram (side view) of an original plate alignment detection system and its surroundings in Embodiment 2.

FIG. 15 is a schematic diagram (plan view) of an original plate alignment detection system and its surroundings in Embodiment 2.

FIG. 16 is a schematic diagram of a pattern which is provided on a second reference plate in Embodiment 2.

FIG. 17 is a schematic diagram of a case where an original plate alignment mark and a second original plate alignment mark are simultaneously observed in Embodiment 2.

### DETAILED DESCRIPTION OF THE PREFERRED EMBODIMENTS

Exemplary embodiments of the present invention will be described below with reference to the accompanied drawings. In each of the drawings, the same elements will be denoted by the same reference numerals and the duplicate descriptions thereof will be omitted.

### Embodiment 1

First, an exposure apparatus in Embodiment 1 of the present invention will be described. An exposure apparatus 100 of the present embodiment is an exposure apparatus which exposes a circuit pattern on an original plate onto a substrate. The exposure apparatus 100 includes an original plate alignment detection system which measures a position of an alignment pattern of the original plate while moving in an in-plane direction of the original plate at a region other than an optical path during exposure (out of an exposure region) in order to measure a position and a shape of the original plate with high accuracy and at high velocity. In the present embodiment, first, an outline of the exposure apparatus and exposure method will be described, and then, an alignment (a position adjustment) of the original plate will be described in detail.

FIG. 2 is a schematic diagram of the exposure apparatus 100 in the present embodiment. The exposure apparatus 100 includes an exposure station 1, a measurement station 2, and a top plate 7. The exposure station 1 is an exposure portion for exposing the pattern of the original plate onto the substrate. On the other hand, the measurement station 2 is a measurement unit for measuring a focus position and an alignment position of the substrate.

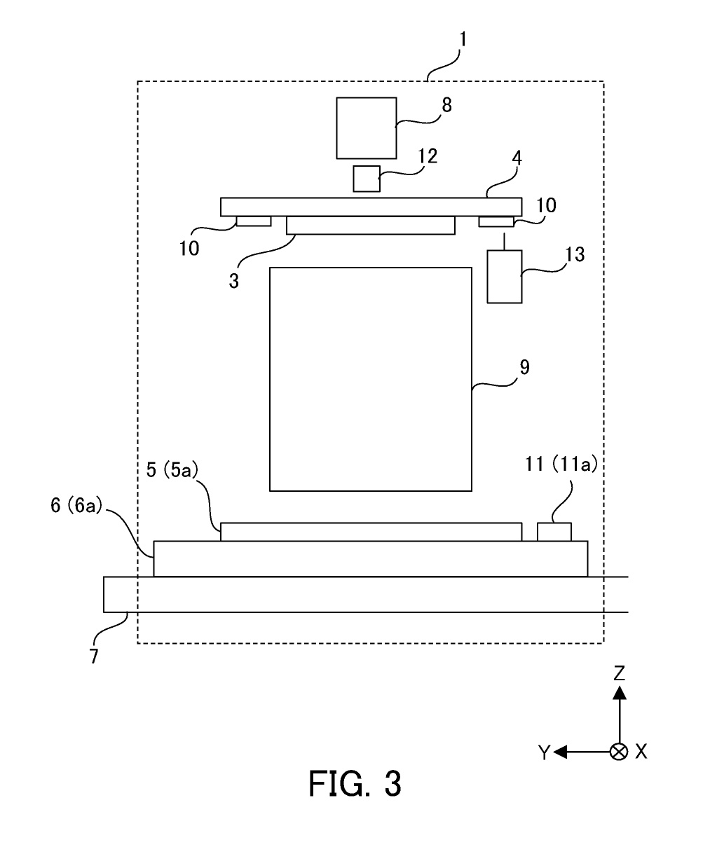

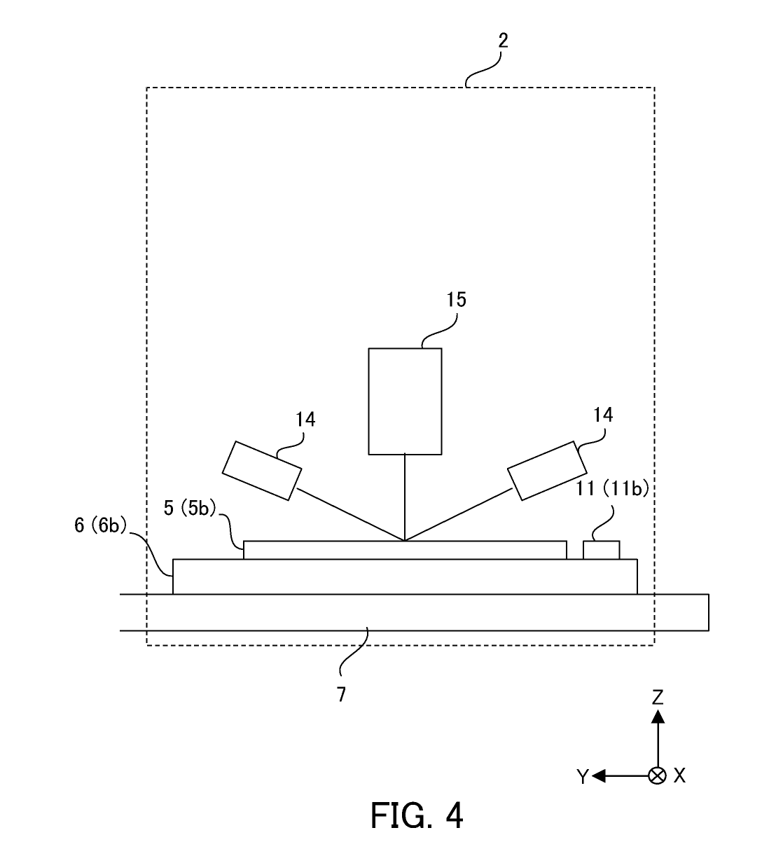

FIG. 3 is a schematic diagram of the exposure station 1 in the present embodiment. FIG. 4 is a schematic diagram of the measurement station 2 in the present embodiment. A substrate stage 6 (6a, 6b) supports the substrate 5 (5a, 5b) and is configured to be movable between the exposure station 1 and the measurement station 2. The top plate 7 supports two substrate stages 6a and 6b. The exposure station 1 shown in FIG. 3 includes an original plate stage 4 which supports the original plate 3 in addition to the substrate stage 6a. The exposure station 1 includes an illumination optical system 8 which illuminates the original plate 3 supported by the original plate stage 4 using light (exposure light) from a light source (not shown) and a projection optical system 9 which performs a projection exposure of the pattern of the original plate 3 illuminated by the exposure light onto the substrate 5a on the substrate stage 6a. Further, the exposure station 1 is provided with a control unit (a controller, not shown) which performs an integrated control for the entire operation of the exposure apparatus 100. In the exposure apparatus 100 of the present embodiment, the two substrate stages 6a and 6b are provided, but an exposure apparatus including one or three or more substrate stages may be applicable.

The exposure apparatus 100 of the present embodiment is a scanner which exposes the pattern formed on the original plate 3 onto the substrate 5a while synchronously scanning the original plate 3 and the substrate 5a in a scanning direction. However, the exposure apparatus of the present embodiment is not limited to this, and a stepper may also be used. Hereinafter, a direction which is coincident with an optical axis of the projection optical system 9 is defined as a Z-axis direction, a synchronously moving direction of the original plate 3 and the substrate 5 in a plane which is vertical to the Z-axis direction (a scanning direction) is defined as a Y-axis direction, and a direction which is vertical to the Z-axis and Y-axis directions (a non-scanning direction) is defined as an X-axis direction. Directions around the X-axis, Y-axis, and Z-axis are defined as θX, θY, and θZ directions, respectively.

A predetermined illumination region on the original plate 3 is illuminated by the exposure light with a uniform illumination distribution using the illumination optical system 8. As exposure light emitted from the illumination optical system 8, commonly, a mercury lamp, a KrF excimer laser, an ArF excimer laser, an F2 laser, extreme ultraviolet light (EUV light), or the like is used. However, the exposure light of the present embodiment is not limited to them.

The original plate stage 4 supports the original plate 3 and is capable of moving in a plane vertical to the optical axis of the projection optical system 9, i.e. two-dimensionally moving in an XY plane, and of slightly rotating in the θZ direction. The original plate stage 4 is driven by an original plate stage driving unit such as a linear motor (not shown). The original plate stage driving unit is controlled by a control unit (not shown). A mirror is provided on the original plate stage 4. At a position opposed to the mirror, a laser interferometer (not shown) is provided. The position in two dimensional directions in the XY plane of the original plate 3 on the original plate stage 4 and the rotational angle θZ are measured by the laser interferometer in real time, and the result is outputted to the control unit. The control unit drives the original plate stage driving unit based on the measurement result of the laser interferometer to perform a positioning control of the original plate 3 supported by the original plate stage 4.

The projection optical system 9 performs a projection exposure of the pattern of the original plate 3 onto the substrates 5a and 5b at a predetermined projection magnification. The projection optical system 9 is configured to include a plurality of optical elements, and these optical elements are supported by an optical barrel that is a metal member. In the present embodiment, the projection optical system 9 is a reduced projection system whose projection magnification is for example ¼ or ⅕.

The substrate stage 6a supports the substrate 5a. The substrate stage 6a includes a Z stage holding the substrate 5a via a substrate chuck, an XY stage supporting the Z stage, and a base supporting the XY stage. The substrate stage 6a is driven by a substrate stage driving unit such as a linear motor (not shown). The substrate stage driving unit is controlled by the control unit.

A mirror that moves along with the substrate stage 6a is provided on the substrate stage 6a. At a position opposed to the mirror, a laser interferometer (not shown) is provided. The position of the substrate stage 6a in the XY direction and the rotational angle θZ are measured by the laser interferometer in real time, and the measurement result is outputted to the control unit. The position of the substrate stage 6a in the Z direction and the rotational angles θX and θY are measured by the laser interferometer in real time, and the measurement result is also outputted to the control unit. An XYZ stage is driven via the substrate stage driving unit based on the measurement result of the laser interferometer to adjust the position of the substrate 5a in the X, Y, and Z directions and perform a positioning control of the substrate 5a supported by the substrate stage 6a.

Above the original plate stage 4, a TTR alignment detection system 12 which detects a mark on a reference plate 10 arranged on the original plate stage 4 and a mark on a reference plate 11 (11a) arranged on the substrate stage 6a is provided. The TTR alignment detection system 12 detects the mark on the reference plate 11a via the projection optical system 9. An alignment (a position adjustment) of the reference plate 11a with respect to the reference plate 10 is performed by using the TTR alignment detection system 12. At a position adjacent to the projection optical system 9, an original plate alignment detection system 13 (an original plate alignment detector) is arranged. The original plate alignment detection system 13 measures a position of the alignment pattern on the original plate 3 or the reference plate 10. The details of the original plate alignment detection system 13 will be described below.

On the other hand, the measurement station 2 shown in FIG. 4 includes a focus detection system 14 which detects position information on a surface of the substrate 5b supported on the substrate stage 6b (position information and tilt information in the Z-axis direction). The measurement station 2 includes a substrate alignment detection system 15 which detects positions of the substrate 5b and the reference plate 11 (11b). The focus detection system 14 includes a projection system which projects detected light onto the surface of the substrate 5b and a light receiving system which receives reflected light from the substrate 5b. The detection result (measured value) of the focus detection system 14 is outputted to the control unit. The control unit drives the Z stage based on the detection result of the focus detection system 14, and adjusts a position (a focus position) in the Z-axis direction and a tilt angle of the substrate 5 which is held on the Z stage. The result (the measured value) of the position detection of the substrate 5b and the reference plate 11b by the substrate alignment detection system 15 is outputted to the control unit as alignment position information in a coordinate specified by the laser interferometer.

The reference plates 11a and 11b are respectively set at the same height as that of the substrates 5a and 5b, and are used for detecting positions of the substrates 5a and 5b by the TTR alignment detection system 12 or the substrate alignment detection system 15. The reference plates 11a and 11b include parts whose surfaces are substantially flat, and also have a role as a reference surface of the focus detection system 14. The reference plates 11a and 11b may also be arranged at a plurality of corners of the substrate stages 6a and 6b, respectively.

Each of the substrates 5a and 5b includes a substrate alignment mark which is detected by the substrate alignment detection system 15. A plurality of substrate alignment marks are provided around each of shot regions on the substrates 5a and 5b, and the position relation between the substrate alignment mark and the shot region (in the X and Y directions) is assumed to be known.

Next, an exposure method in the present embodiment will be described. As described above, in the exposure apparatus 100 which is provided with two substrate stages 6a and 6b, for example, the exchange and the measurement process of the substrate 5b on the substrate stage 6b in the measurement station 2 is performed during the exposure process of the substrate 5a on the substrate stage 6a in the exposure station 1. When each process is finished, the substrate stage 6a in the exposure station 1 moves to the measurement station 2, and in parallel with that, the substrate stage 6b of the measurement station 2 moves to the exposure station 1 and the exposure process is performed for the substrate 5b. Hereinafter, an outline of the exposure process in the present embodiment will be described in order.

After the substrate 5b is carried in the measurement station 2, the reference plate 11b is detected by the substrate alignment detection system 15. Therefore, the control unit moves the XY stage while monitoring the output of the laser interferometer so that an optical axis of the substrate alignment detection system 15 is located on the reference plate 11b. Thus, position information of the reference plate 11b is measured by the substrate alignment detection system 15 in a coordinate system specified by the laser interferometer. Similarly, in the measurement station 2, position information of the surface of the reference plate 11b is detected by the focus detection system 14.

Next, the position detection of the shot region of the substrate 5b is performed. The control unit moves the substrate stage 6b while monitoring the output of the laser interferometer so that the optical axis of the substrate alignment detection system 15 moves on the substrate alignment mark which is positioned around each shot region of the substrate 5b. Then, the substrate alignment detection system 15 detects the substrate alignment mark formed around the shot region of the substrate 5b. Thus, the position of each substrate alignment mark in the coordinate system specified by the laser interferometer is detected.

The position relation between the reference plate 11b and each substrate alignment mark is obtained by the detection result of the reference plate 11b and each substrate alignment mark by the substrate alignment detection system 15. Because the position relation between each substrate alignment mark and each shot region is known, the position relation between the reference plate 11b and each shot region on the substrate 5b in the XY plane is also be determined.

Next, the position information of the surface of the substrate 5b for each of all shot regions on the substrate 5b is detected by the focus detection system 14. The control unit relates the detection result to a position in the XY direction in the coordinate system specified by the laser interferometer to store it. The position relation between the surface of the reference plate 11b and the surface of each shot region on the substrate 5b is determined by the detection result of the position information of the surface of the reference plate 11b and the position information of all shot region surfaces on the substrate 5b by the focus detection system 14.

Next, the substrate 5b measured in the measurement station 2 is moved to the exposure station 1 to perform an exposure in the exposure station 1. In the exposure station 1, the original plate 3 is previously placed on the original plate stage 4 and the position and the shape of the pattern of the original plate 3 are measured. The methods of measuring and correcting the position and the shape of the pattern of the original plate 3 will be described below.

The control unit moves the XY stage (the substrate stage 6a) so that the reference plate 11a can be detected by using the TTR alignment detection system 12. Next, the reference plate 11a is detected by the TTR alignment detection system 12 via the original plate 3 and the projection optical system 9. In other words, the relationship between the original plate 3 and the reference plate 11a in the X and Y directions and the Z direction is detected via the projection optical system 9. Thus, the position of the pattern image of the original plate 3 which is projected onto the substrate 5a by the projection optical system 9 is detected by using the reference plate 11a.

When the position detection of the pattern image of the original plate 3 which is formed by the projection optical system 9 is finished, the control unit moves the XY stage to move the shot region on the substrate 5a under the projection optical system 9 in order to expose each shot region on the substrate 5a. Then, the control unit performs a scanning exposure for each shot region on the substrate 5a using each measurement result obtained in the measurement station 2. During the scanning exposure, the alignment (the position adjustment) between the substrate 5 and the original plate 3 is performed based on a position relation between the reference plate 11b and each shot region obtained in the measurement station 2 and a projection position relation between the reference plate 11a and the original plate 3 obtained in the exposure station 1.

Further, during the scanning exposure, the position relation between the surface of the substrate 5a and the pattern image surface of the original plate 3 projected by the projection optical system 9 is adjusted. The adjustment is performed by the position relation between the surface of the reference plate 11b and the surface of the substrate 5b obtained in the measurement station 2 and the position relation between the surface of the reference plate 11a and the pattern image surface of the original plate 3 formed by the projection optical system 9, which has been obtained in the exposure station 1.

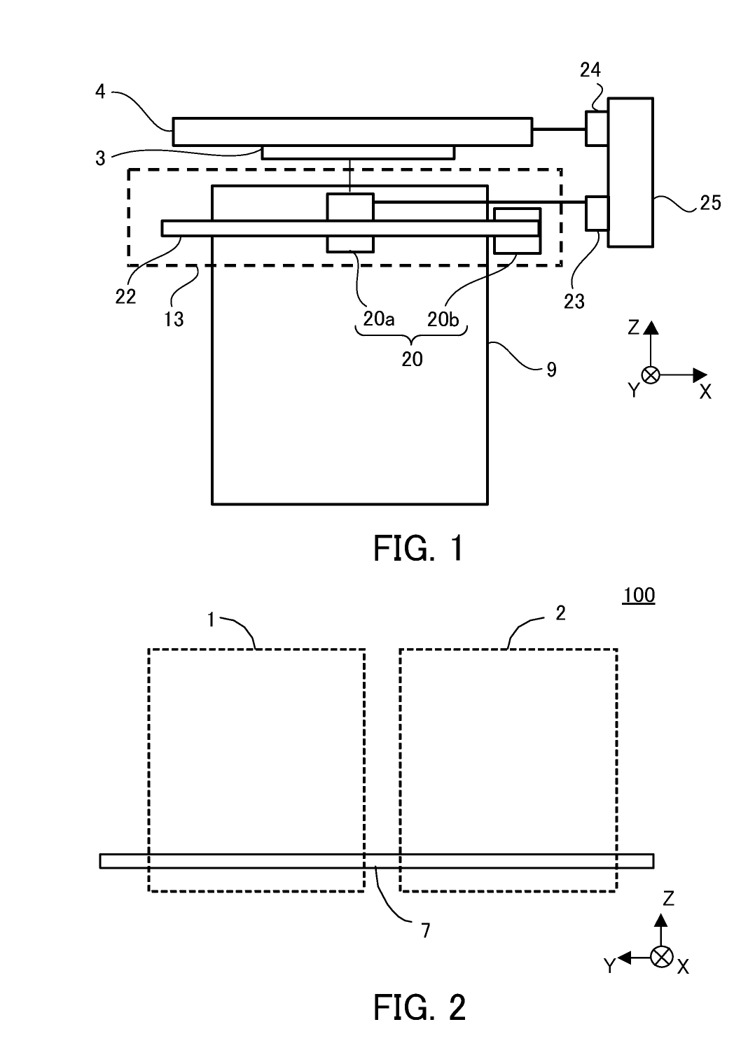

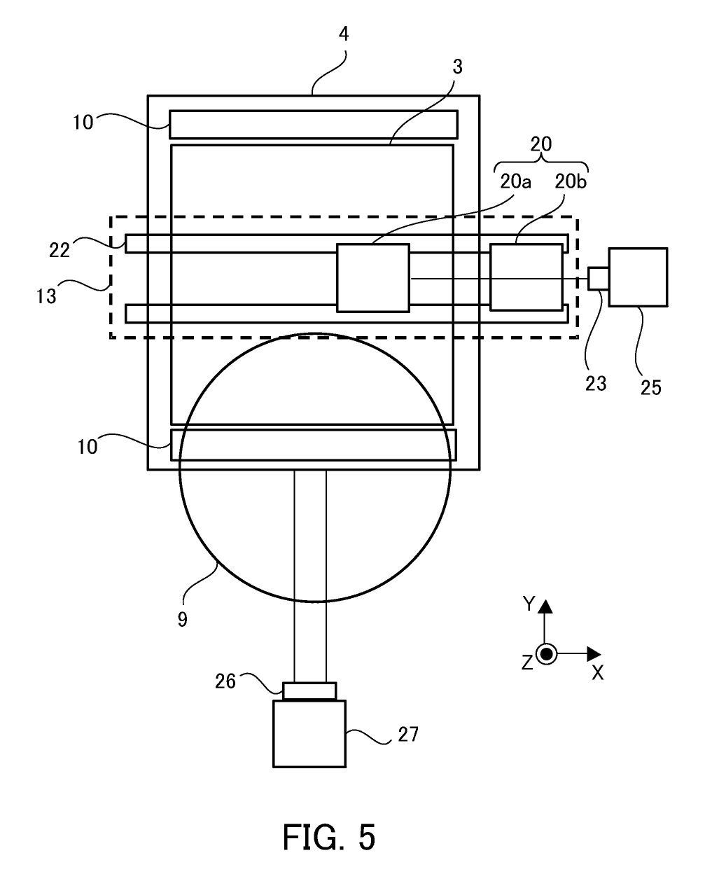

Next, the measurement and the correction of the pattern of the original plate 3 in the present embodiment will be described. FIGS. 1 and 5 are schematic diagrams of the original plate alignment detection system 13 and its surroundings. FIG. 1 is a side view when the original plate alignment detection system is viewed in a Y direction, and FIG. 5 is a plan view when the original plate alignment detection system is viewed from the upper side of the apparatus (in a Z direction).

As described above, in FIGS. 1 and 5, reference numeral 3 denotes an original plate, reference numeral 4 denotes an original plate stage, reference numeral 9 denotes a projection optical system, and reference numeral 13 denotes an original plate alignment detection system (an original plate alignment detector). Reference numeral 20 denotes an original plate alignment scope which illuminates the original plate 3 or the reference plate 10 and takes an image of an alignment mark on the original plate 3 or the reference plate 10 by receiving the reflected light. The original plate alignment scope 20 is configured to include a movable member 20a and a stationary member 20b. Reference numeral 22 denotes an original plate alignment driving system which holds the original plate alignment scope 20 (the movable member 20a and the stationary member 20b) by a guide and drives the movable member 20a of the original plate alignment scope 20 in an X direction. Reference numeral 23 denotes an interferometer which measures a position of the original plate alignment scope (the movable member 20a). The interferometer 23 is a measurement unit which measures a position of the original plate alignment detection system 13. Reference numeral 24 denotes an interferometer which measures a position of the original plate stage 4 in the X direction. Reference numeral 25 denotes a column which supports the interferometers 23 and 24. Similarly, reference numeral 26 denotes an interferometer which measures a position and a rotational angle of the original plate stage 4 in a Y direction. Reference numeral 27 denotes a column which supports the interferometer 26.

As shown in FIG. 5, the original plate alignment detection system 13 provided in the exposure apparatus 100 is positioned at a location (an outside of an edge of the projection optical system 9 in FIG. 5) other than an optical path (other than an exposure region) during the exposure. The original plate alignment detection system 13 moves in an in-plane direction of the original plate 3 (in the X and Y directions) at an outside of the exposure region to measure a position of a plurality of alignment patterns of the original plate 3. Therefore, an evacuation process from the inside of the exposure region of the original plate alignment scope 20 is not necessary. The original plate alignment detection system 13 includes a mechanism (the original plate alignment driving system 22) which moves it in a direction (in the X direction) vertical to a moving direction (the Y direction) of the original plate 3 (the original plate stage 4) during the exposure. Therefore, in combination with a driving mechanism which drives the original stage in the Y direction, a pattern at an arbitrary position on the original plate 3 can be measured at high velocity. In FIGS. 1 and 5, the configuration where one original plate alignment scope 20 is included, but the present embodiment is not limited to this and a plurality of original plate alignment scopes may also be included. A measurement time for measuring a position of the alignment pattern of the original plate can be shortened and throughput of the exposure apparatus can be improved by using the plurality of original plate alignment scopes.

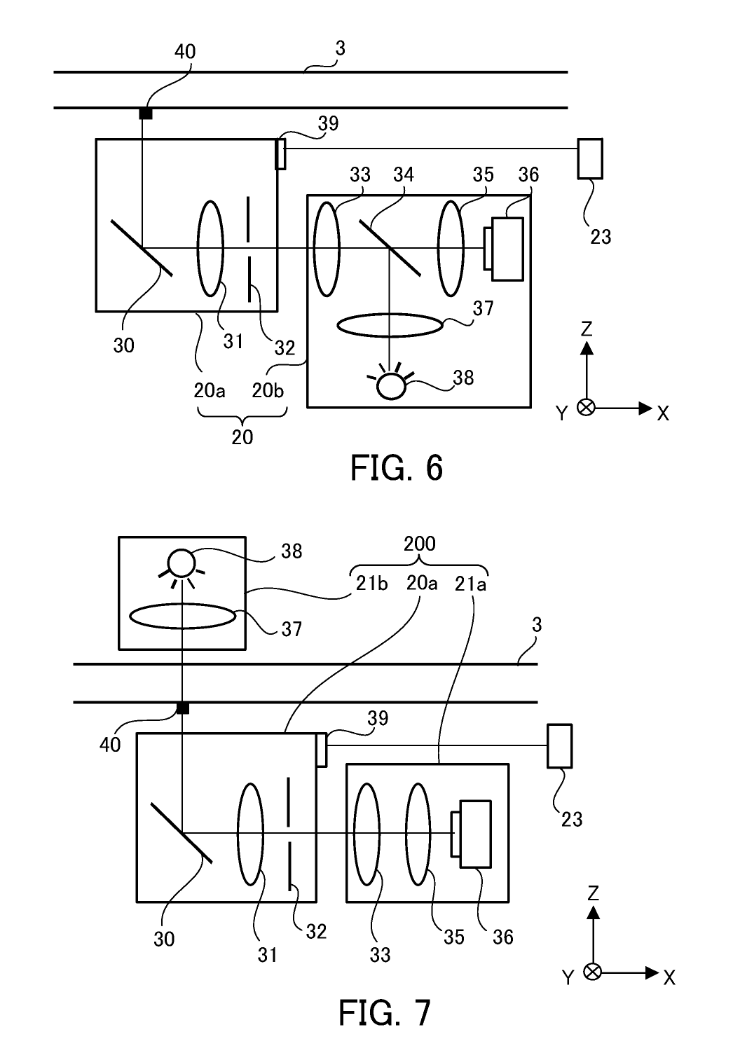

Next, the original plate alignment scope 20 and the original plate alignment driving system 22 will be specifically described. FIG. 6 is a schematic diagram showing one example of the original plate alignment scope 20 in the present embodiment. Illumination light from a light source 38 is reflected by a beam splitter 34 via a collecting lens 37 and enters a relay lens 33. The illumination light from the relay lens 33 becomes parallel light (afocal) and passes through an aperture 32 to enter an objective lens 31. The objective lens 31 forms an image of an object (an alignment mark on the original plate) at infinity, and its image is corrected so as not to have aberration for the object at infinity. On the other hand, the relay lens 33 is corrected so as to be imaged without aberration for the object at infinity. Therefore, an alignment mark image on the original plate is imaged as an intermediate image at a side of the beam splitter 34 via the relay lens 33. In this case, due to the above configuration, even when the interval between the objective lens 31 and the relay lens 33 is changed, the deterioration of the image quality of the imaged intermediate image is within a permissible range.

The illumination light from the objective lens 31 is reflected by a mirror 30 to illuminate an alignment mark 40 which is patterned on a lower surface of the original plate 3. The image of the alignment mark 40 that is observation light reflected by the original plate 3 passes through the mirror 30, the objective lens 31, the aperture 32, the relay lens 33, the beam splitter 34, and the image forming optical system 35 again to be imaged by an image pickup element 36. The position of the image of the alignment mark 40 imaged by the image pickup element 36 is calculated by performing various image processing detections by a calculator (not shown). The calculator calculates a position and a shape of the original plate 3 from positions of a plurality of alignment marks. A correction unit (not shown) corrects the position and the shape of the original plate 3 during the exposure. In other words, the correction unit performs a correction in accordance with the position and the shape of the original plate 3 calculated by the calculator.

The aperture 32, the objective lens 31, and the mirror 30 are arranged in the movable member 20a of the original plate alignment scope 20. These elements are held by the original plate alignment driving system 22, and are configured to be movable in the X direction along the guide of the original plate alignment driving system 22. Such a configuration can change an observation image height.

The movable member 20a of the original plate alignment scope 20 is provided with a reference mirror 39 used for the interferometer, and an accurate measurement of a position in an X direction can be performed by the interferometer 23. The position of the movable member 20a of the original plate alignment scope 20 is controlled by the original plate alignment driving system 22 based on a measured value of the interferometer 23. Although the interval between the objective lens 31 and the relay lens 33 changes in accordance with the movement of the movable member 20a of the original plate alignment scope 20, the optical path is afocal and is configured so as not to be affected by an imaging state.

When the alignment mark 40 on the original plate 3 is observed, illumination light other than exposure light used in exposing the pattern of the original plate 3 onto the substrates 5a and 5b (non-exposure light) is used because the projection optical system 9 is not mediated. For example, it can be realized by using a known LED. When the light source of the non-exposure light can not be arranged due to limitations of space or the like, the exposure light may be used. In this case, it can be realized by inputting the exposure light diverged by a mirror or the like from the illumination optical system 8 into the original plate alignment detection system 13 by using a fiber or the like.

As described above, the original plate alignment scope 20 shown in FIG. 6 is configured to receive reflected light from the original plate 3. However, the present embodiment is not limited to this and a configuration where the image of the alignment mark 40 is received by using the illumination light transmitted through the original plate 3 can also be adopted. FIG. 7 is a schematic diagram showing another example of the original plate alignment scope 20 in the present embodiment.

The original plate alignment scope 200 shown in FIG. 7 is configured so that the stationary member 21 is separated into an illumination portion 21a and a light receiving portion 21b. The illumination portion 21a is arranged at an upper side of the original plate 3 and moves along with the movable member 20a of the original plate alignment scope 200. The beam splitter 34 in FIG. 6 is not necessary for the original plate alignment scope 200 in FIG. 7. In the configuration of FIG. 7, the illumination light from the light source 38 illuminates the alignment mark 40 which is patterned on the lower surface of the original plate 3 via the collecting lens 37 and the original plate 3. The image of the alignment mark 40 that is illumination light transmitted through the original plate 3 passes through the mirror 30, the objective lens 31, the aperture 32, the relay lens 33, and the image forming optical system 35 to be imaged by the image pickup element 36. In FIG. 7, similarly to FIG. 6, the illumination light from the relay lens 33 is parallel light (afocal) and the objective lens 31 forms an image at infinity in a state where an aberration of an object is corrected.

Arrangements of the movable member 20a and the illumination portion 21a arranged at the lower side of the original plate 3 in FIG. 7 can also be replaced with the light receiving portion 21b arranged at the upper side of the original plate 3. When as an exposure light source, the exposure apparatus uses an ArF laser, a KrF laser, a mercury lamp, or the like, both configurations shown in FIGS. 6 and 7 can be adopted because the original plate 3 is made of glass as a material. On the other hand, in a case of an exposure apparatus which uses EUV light as an exposure light source, the configuration of FIG. 6 is adopted because the reflective original plate 3 is used.

Hereinafter, the description of the original plate alignment driving system 22 will be supplemented. The original plate alignment driving system 22 is a drive unit which drives the movable member 20a of the original plate alignment scope 20 in an X direction. Because the position of the movable member 20a itself influences on the measured value, a highly-accurate position measurement of the movable member 20a is required. The position of the movable member 20a in the X direction is measured by the interferometer 23 with high accuracy. The position of the movable member 20a in a Y direction is a position along a guide in the original plate alignment driving system 22. The guide is manufactured and adjusted with high accuracy so that the movable member 20a is always at the same position in the Y direction. With regard to errors generated in the process of the manufacture and the adjustment, for example, a mark on the reference plate 10 provided on the original plate stage 4 is measured by the original plate alignment detection system 13 to previously calculate a correction value to perform a correction when measuring a mark on the original plate 3.

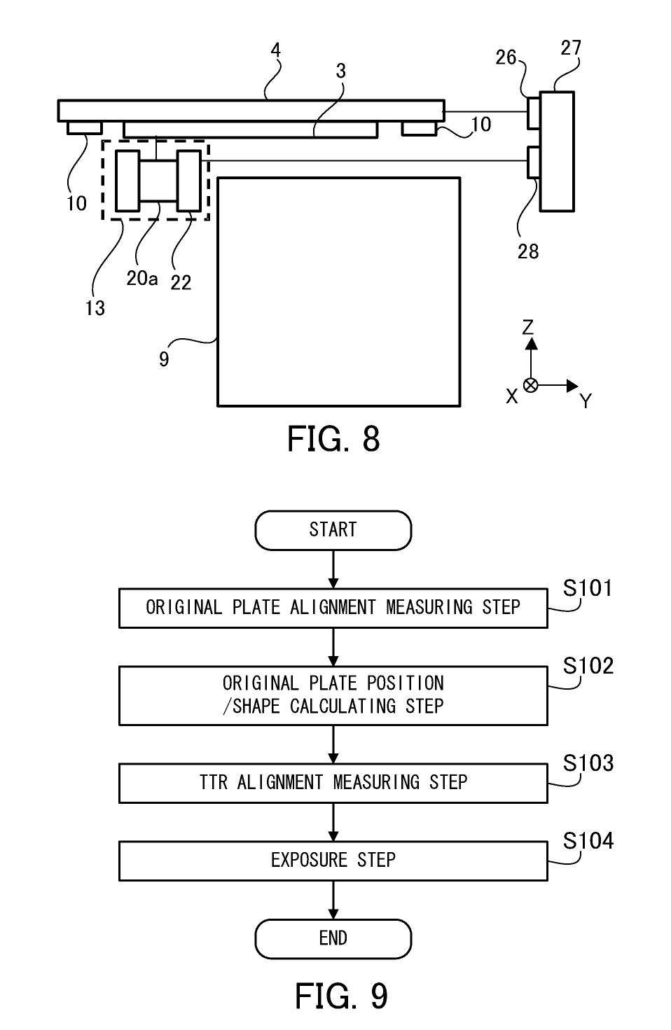

FIG. 8 is a schematic diagram of an original plate alignment detection system and its surroundings as another example in the present embodiment, and is a side view when viewed in an X-axis direction. As shown in FIG. 8, in order to precisely recognize a position of the movable member 20a in a Y direction, a mirror may be arranged at the guide of the original plate alignment driving system 22 and a two-axial interferometer 28 may also be provided. Such a configuration can measure a moving amount and a rotational angle of the guide caused by vibration or the like, and position change of the movable member 20a in the Y direction can be measured. For example, the measured value may be corrected by using the position change of the movable member 20a in the Y direction, and the position of the original plate stage 4 during the measurement may also be corrected. In the present embodiment, the position of the movable member 20a is measured by using the interferometer 28, but the present embodiment is not limited to this, and for example a measurement device such as a known encoder, other than an interferometer, may also be used. The present embodiment adopts a configuration where the movable member 20a is driven in the X direction, but may be configured so that the drive unit is provided at both sides in the X and Y directions to drive the movable member 20a in both the X and Y directions.

Next, methods of measuring and correcting a shape and a position of the original plate 3 in the present embodiment will be described. FIG. 9 is a flowchart of the methods of measuring and correcting them. First, in an original plate alignment measuring step S101, positions of a plurality of alignment marks which are provided on the original plate 3 or the reference plate 10 are measured. Next, in an original plate position/shape calculating step S102, the shape and the position of the original plate 3 is calculated from the measured value of the position of the alignment mark. Subsequently, in a TTR alignment measuring step S103, a position of the original plate 3 with respect to the substrate stages 6a and 6b via the projection optical system 9 (a position displacement between the substrate stage 6 and the original plate 3) is measured. Finally, in an exposure step S104, the above exposure process is performed based on the shape and the position of the original plate 3 calculated by a calculator (not shown) from the measured value. In other words, a correction unit (not shown) performs a correction in accordance with the position and the shape of the original plate 3 calculated by the calculator during the exposure.

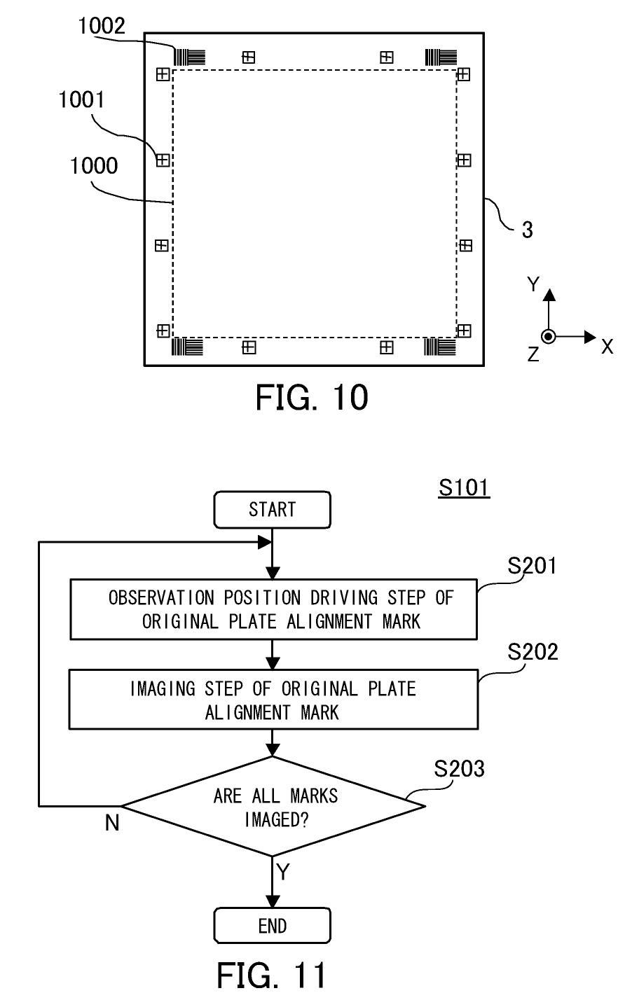

Subsequently, the alignment mark provided on the original plate will be described. FIG. 10 is a schematic diagram (a plan view) of the original plate on which the alignment mark is provided. In FIG. 10, reference numeral 1000 denotes a circuit pattern region in the original plate 3. Two kinds of alignment marks are patterned outside the circuit pattern region of the original plate 3. Reference numeral 1001 denotes an alignment mark for performing an original plate alignment (hereinafter, referred to as an “original plate alignment mark”), and reference numeral 1002 denotes a TTR alignment mark for performing a TTR alignment mark (hereinafter, referred to as a “TTR alignment mark”). The TTR alignment detection system 12 is configured to simultaneously observe the alignment mark for performing the TTR alignment on the original plate and the alignment mark on the reference plate 11. Based on a relative position displacement between them, a relative position displacement between the original plate 3 and the substrate stage 6 in the X and Y directions is detected.

Next, the original plate alignment measuring step S101 in FIG. 9 will be described in detail. FIG. 11 is a flowchart of the original plate alignment measuring step S101. In the original plate alignment measuring step S101, a position of the original plate alignment mark 1001 on the original plate 3 previously selected is measured. First, in an observation position driving step of the original plate alignment mark S201, the original plate alignment mark 1001 moves in the visual field of the original plate alignment detection system 13. The original plate alignment mark 1001 is driven in an X direction by the movable member 20a of the original plate alignment scope 20, and is driven in a Y direction by the original plate stage 4.

Subsequently, in an imaging step of the original plate alignment mark 5202, the original plate alignment mark 1001 is imaged to calculate a position of the original plate alignment mark 1001. In the step S203, the steps S201 and S202 are repeated until all original plate alignment marks 1001 previously selected are imaged and the determination of the position calculation is performed. The position calculation of the original plate alignment mark 1001 may also be collectively performed after all the original plate alignment marks 1001 are imaged.

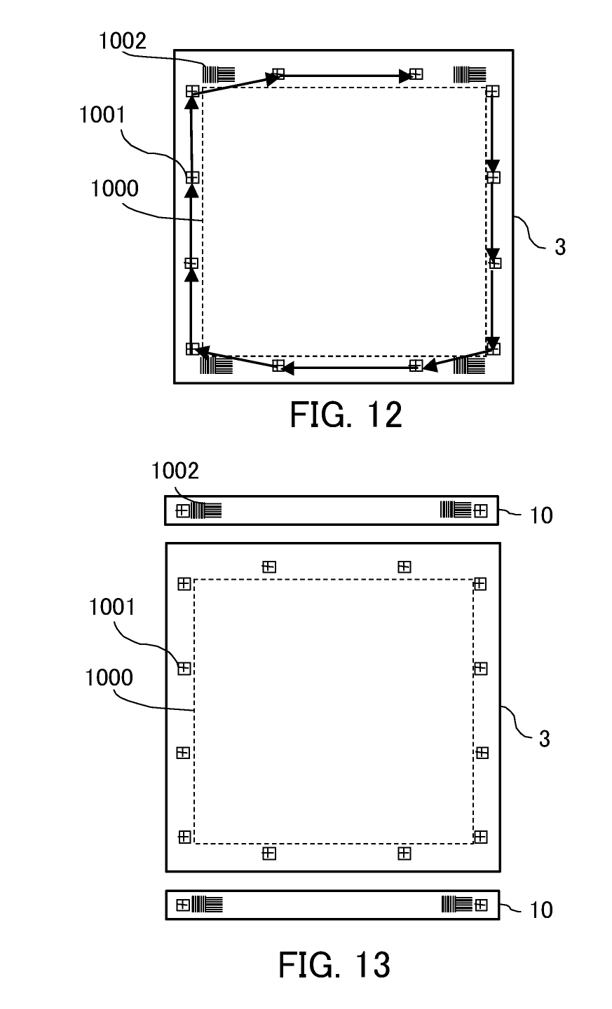

FIG. 12 is one example of an imaging order of the original plate alignment mark 1001. The imaging order indicated by an arrow in FIG. 12 is determined by giving priority to the driving of the original stage 4 in the Y direction. This is because the driving velocity of the original plate stage 4 is commonly faster than that of the original plate alignment scope 20. In accordance with the driving velocities of the original plate alignment scope 20 and the original plate stage 4, a measurement order of the original plate alignment mark 1001 can be properly set. If a plurality of original plate alignment detection systems 13 are provided, a faster measurement can be performed. Further, in FIG. 12, the original plate alignment mark 1001 which is at the outside of the circuit pattern region of the original plate 3 is measured, but the present embodiment is not limited to this. For example, a position of the original plate alignment mark which is at the inside of the circuit pattern region or the circuit pattern may also be measured.

Next, the original plate position/shape calculating step S102 in FIG. 9 will be described. In the original plate position/shape calculating step S102, the position and the shape of the original plate 3 are calculated from the measured value obtained in the original plate alignment measuring step S101. Hereinafter, one example of methods of calculating the position and the shape of the original plate 3 will be described. In the present embodiment, the position and the shape of the original plate 3 are calculated using the following two Expressions (1) and (2) which represent a relationship between a design position (xᵣ, yᵣ) of the original plate 3 and a real position (xᵣₛ, yᵣₛ) of the original plate 3 corresponding to the design position on the original plate stage 4.

xᵣₛ=aₓ₁+bₓ₁xᵣ+cₓ₁yᵣ+dₓ₁xᵣ²+eₓ₁xᵣyᵣ+fₓ₁yᵣ²+gₓ₁xᵣ³+hₓ₁xᵣ²yᵣ+iₓ₁xᵣyᵣ²+jₓ₁yᵣ³+ . . . (1)

yᵣₛ=a_{y1}+b_{y1}xᵣ+c_{y1}yᵣ+d_{y1}xᵣ²+e_{y1}xᵣyᵣ+f_{y1}yᵣ²+g_{y1}xᵣ³+h_{y1}xᵣ²yᵣ+i_{y1}xᵣyᵣ²+j_{y1}yᵣ³+ . . . (2)

Expressions (1) and (2) are polynomials having an arbitrary order where the design position on the original plate is a variable. In the original plate position/shape calculating step S102, predetermined coefficients aₓ₁˜jₓ₁ . . . , and a_{y1}˜j_{y1} . . . in Expressions (1) and (2) are obtained from the measured value. Specifically, each of the design values {(xᵣ₁, yᵣ₁), (xᵣ₂, yᵣ₂), . . . (x_{rN}, y_{rN})} of the alignment marks on the original plate and the alignment mark measured values {(xᵣₛ₁, yᵣₛ₁), (xᵣₛ₂, yᵣₛ₂), . . . (x_{rsN}, y_{rsN})} are used. Then, these values are used to be able to obtain the coefficients by solving a normal equation by a least squares approximation method. In the embodiment, “N” indicates the number of the measured original plate alignment marks. As a solving method of the normal equation, a method of using a known LU resolution is common.

In the present embodiment, Expressions (1) and (2) are described as polynomials having an arbitrary order, but the terms constituting Expressions (1) and (2) need to be previously determined at the time of actually using them. The terms are, for example, determined based on an error that can be corrected by the exposure apparatus described below. In other words, an expression constituted by a part of terms of Expressions (1) and (2) is determined. Commonly, the exposure apparatus can control a projection optical system magnification when exposing the original plate onto the substrate. The terms of bₓ₁xᵣ of Expression (1) and c_{y1}yᵣ of Expression (2), which are magnification components capable of being corrected by the control of the projection optical system magnification, are used. Further, commonly, a rotational component of the original plate with respect to the original plate stage can also be corrected by controlling a driving direction of the substrate stage or the original plate stage. Therefore, the terms of cₓ₁yᵣ of Expression (1) and b_{y1}xᵣ of Expression (2) are used. Thus, in accordance with the error which can be corrected by the exposure apparatus, the terms of Expressions (1) and (2) are previously determined.

Next, a TTR alignment measuring step S103 in FIG. 9 will be described in detail. In the TTR alignment measuring step S103, a position of the original plate 3 with respect to the substrate stage 6 via the projection optical system 9 is measured. Specifically, the TTR alignment mark 1002 on the original plate 3 and the alignment mark on the reference plate are simultaneously observed, and a relative position displacement between the original plate 3 and the substrate stage 6 via the projection optical system 9 is detected from a relative position displacement between both marks.

Next, the exposure step S104 in FIG. 9 will be described. Based on the original plate position/shape calculating step S102, the TTR alignment measuring step S103, and the substrate shape previously measured by the measurement station 2, the pattern of the original plate 3 is corrected while overlapping the original plate 3 with the substrate 5. The overlap between the original plate 3 and the substrate 5 is corrected using for example the following correction unit during the exposure.

When the exposure apparatus is a stepper, the correction can be performed by the following method. (1) A stage which holds a substrate is driven to correct a position displacement (shift) of each exposure region in X and Y directions. (2) A magnification error in each exposure region is corrected by a projection magnification correcting portion which drives a levitation lens in a projection lens in an upward and downward direction. (3) A rotational error in each exposure region is corrected by a relative rotational correcting portion which relatively rotates the stage holding the substrate and an original stage holding an original plate. (4) Distortion in each exposure region is corrected by a portion of changing a relative position of a pair of optical elements having aspherical surfaces which are the same shape each other in the projection lens to correct the distortion.

When the exposure apparatus is a scanner, the correction can be performed by the following method. (1) A stage which holds a substrate is driven to correct a position displacement (shift) of each exposure region in X and Y directions. (2) A magnification error in a non-scanning direction in each exposure region is corrected by a projection magnification correcting portion which drives a levitation lens in a projection lens in an upward and downward direction. (3) Distortion in each exposure region is corrected by a portion of changing a relative position of a pair of optical elements having aspherical surfaces which are the same shape each other in the projection lens to correct the distortion. (4) Scanning directions of the original stage which holds the original plate and the stage which holds the substrate are relatively adjusted to correct the rotational error in each exposure region. (5) A scanning velocity of the stage which holds the substrate is adjusted to correct the scanning direction magnification in each exposure region.

As described above, in the present embodiment, an example where the pattern of the original plate 3 is measured by using the original plate alignment detection system 13 and the positions of the patterns of the original plate 3 and the reference plate 11 are measured by using the TTR alignment detection system 12 has been described. However, the present embodiment is not limited to this. FIG. 13 is one example where an alignment mark is arranged on the original plate 3 and the reference plate 10. As shown in FIG. 13, for example, the original plate alignment mark 1001 and the TTR alignment mark 1002 are arranged on the reference plate 10, and the relationship between the original plate 3 and the substrate stage 6 may also be measured according to the following procedure.

In this case, in the original plate alignment measuring step S101 in FIG. 9, the original plate alignment mark 1001 on the original plate 3 and the original plate alignment mark on the reference plate 10 are measured using the original plate alignment detection system 13. In the original plate position/shape calculating step S102, the position and the shape of the original plate 3 with respect to the reference plate 10 is calculated. In the TTR alignment measuring step S103, positions of the TTR alignment mark 1002 on the reference plate 10 and a TTR alignment mark (not shown) on the reference plate 11 are measured using a TTR alignment detection system 12. Thus, the relationship between the original plate 3 and the substrate stage 6 is measured via the reference plate 10. In this method, although the alignment mark on the reference plate 10 needs to be measured, the TTR alignment mark 1002 does not have to be arranged on the original plate 3.

According to the present embodiment, because the position and the shape of the original plate are measured at the outside of the axis of the projection optical system, the measurement of the original plate can also be performed during the operation of the substrate stage and the throughput of the exposure apparatus can be improved. Further, because a drive unit is provided in the original plate alignment detection system which measures an alignment mark of the original plate, an alignment mark which is located on an arbitrary position can be measured and the original plate can be overlapped with the substrate plate with high accuracy.

### Embodiment 2

Next, an exposure apparatus in Embodiment 2 of the present invention will be described. The exposure apparatus in Embodiment 2 is different from that of Embodiment 1 in that it can perform the measurement as described above without using an interferometer. In the present embodiment, since other configurations are the same as those of Embodiment 1, descriptions thereof will be omitted.

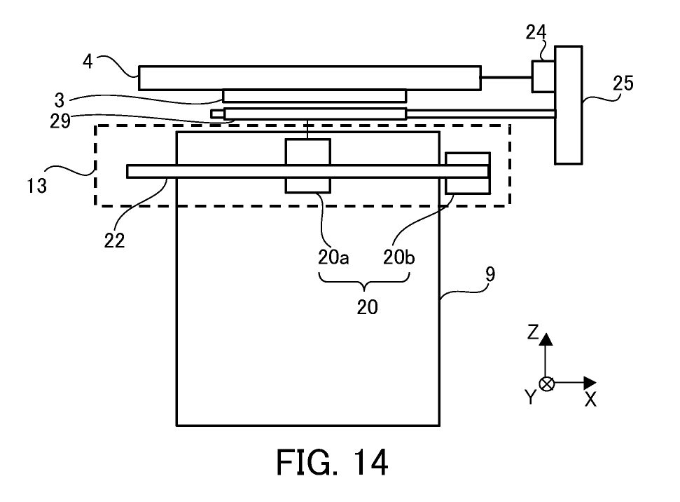

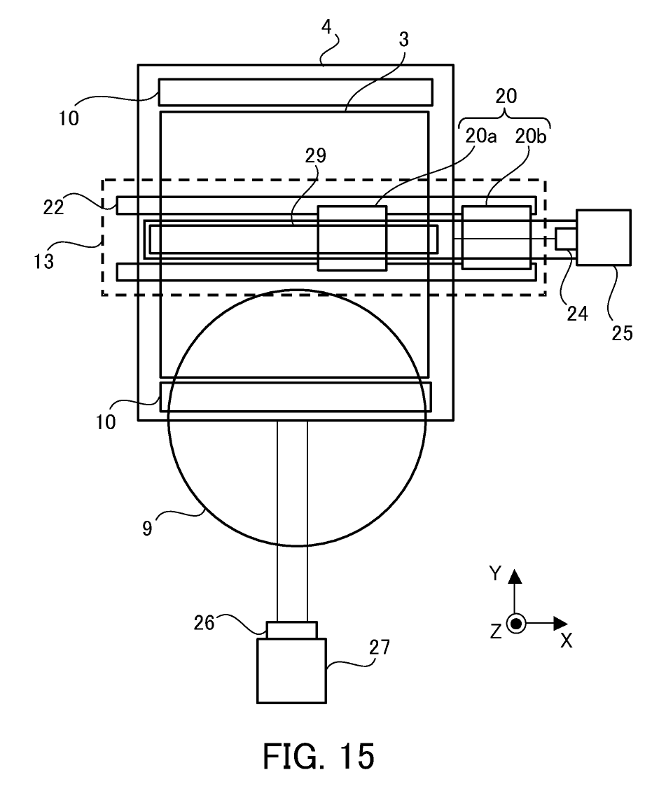

FIGS. 14 and 15 are schematic diagrams of an original plate alignment detection system and its surroundings in the present embodiment. FIG. 14 is a side view when viewed in a Y direction, and FIG. 15 is a plan view when viewed from an upper side (in a Z direction) of the exposure apparatus. In FIGS. 14 and 15, since the same reference codes as those in FIGS. 1 and 5 represent the same elements as those in these drawings, descriptions thereof will be omitted.

In the exposure apparatus of the present embodiment, as compared with the exposure apparatus of Embodiment 1, a second reference plate 29 is added, and on the other hand, the interferometer 23 is removed. The second reference plate 29 is made of glass or the like on which a pattern is formed, and is supported by a column 25. In the present embodiment, the original plate alignment scope 20 is configured to be able to observe the original plate 3 via the second reference plate 29. Thus, the second original plate 29 is used as a measurement unit which measures a position of the original plate alignment detection system 13.

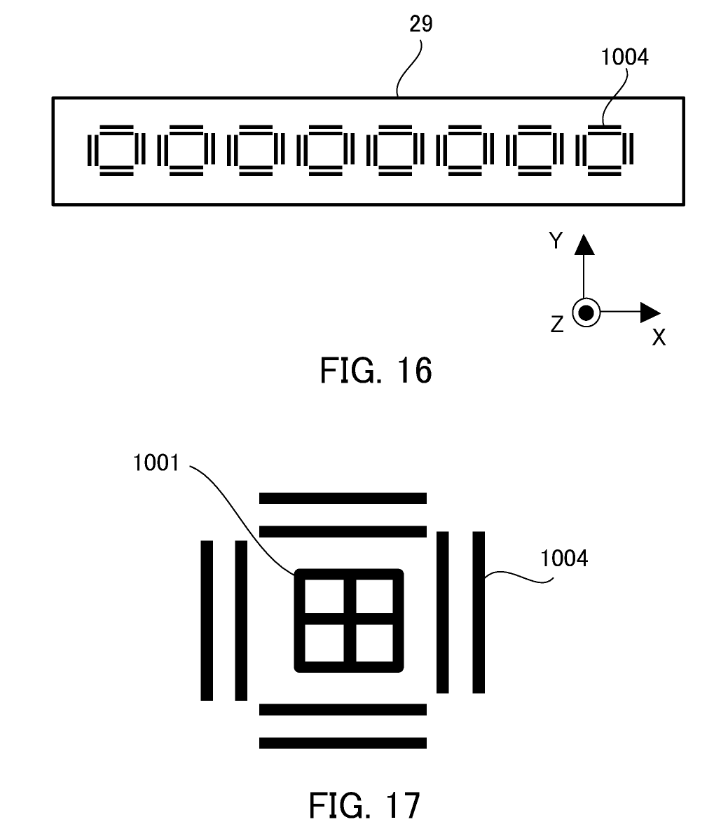

FIG. 16 is a schematic diagram of a pattern formed on the second reference plate 29. As shown in FIG. 16, on the second reference plate 29, a plurality of second original plate alignment marks 1004 are arranged in an X direction. FIG. 17 is a schematic diagram of a case where the original plate alignment mark 1001 and the second original plate alignment mark 1004 are simultaneously observed. As shown in FIG. 17, the original plate alignment scope 20 is configured to simultaneously observe the original plate alignment mark 1001 on the original plate 3 and the second original plate alignment mark 1004 on the second reference plate 29 to measure the displacement between both the marks.

In the present embodiment, because the position of the original plate alignment mark 1001 on the original plate 3 can be measured based on the second reference plate 29, the position of the original plate alignment scope 20 which moves in the X direction does not have to be measured by using an interferometer or the like. However, it is preferable that the second reference plate 29 is configured so that its variation is suppressed as much as possible. It is preferable that the original plate and the second reference plate do not contact each other and they are arranged adjacent to each other to the extent capable of simultaneously observing the original plate alignment mark and the second original plate alignment mark by the original plate alignment scope. Also in the present embodiment, various kinds of configurations described in Embodiment 1 can also be applied. In the present embodiment, because the reference plate cheaper than the interferometer in Embodiment 1 is provided instead of the interferometer, the exposure apparatus which is cheaper and improves throughput can be provided.

A device (a semiconductor integrated circuit device, a liquid crystal display device, or the like) is manufactured by a step of exposing a substrate (a wafer, a glass plate, or the like) which is coated by a photosensitizing agent using the exposure apparatus in any one of the above embodiments, a step of developing the substrate, and other well-known steps.

According to each of the above embodiments, an exposure apparatus capable of correcting a position and a shape of an original plate at high velocity and with high accuracy can be provided. A device manufacturing method which improves the productivity using the exposure apparatus can also be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-036543, filed on Feb. 19, 2009, which is hereby incorporated by reference herein in its entirety.

What is claimed is:

1. An exposure apparatus which exposes a pattern of an original plate onto a substrate, the exposure apparatus comprising:
an original plate alignment detector configured to move the original plate in an in-plane direction at an outside of an exposure region to measure positions of a plurality of alignment marks of the original plate;
a measurement unit configured to measure a position of the original plate alignment detector;
a calculator configured to calculate a position and a shape of the original plate from the positions of the plurality of alignment marks; and
a correction unit configured to perform a correction in accordance with the position and the shape of the original plate during exposure.

2. An exposure apparatus according to claim 1,
wherein the original plate alignment detector is configured to move in a direction vertical to a moving direction of the original plate during the exposure.

3. An exposure method of exposing a pattern of an original plate onto a substrate, the exposure method comprising the steps of:
moving the original plate alignment detector in an in-plane direction of the original plate at an outside of an exposure region to measure positions of a plurality of alignment marks formed on the original plate;
measuring a position of the original plate alignment detector;
calculating a position and a shape of the original plate from the positions of the plurality of alignment marks; and
performing a correction in accordance with the position and the shape of the original plate during exposure.

4. An exposure method according to claim 3,
wherein the position and the shape of the original plate are calculated by using at least a part of the following polynomials,
xᵣₛ=aₓ₁+bₓ₁xᵣ+cₓ₁yᵣ+dₓ₁xᵣ²+eₓ₁xᵣyᵣ+fₓ₁yᵣ²+gₓ₁xᵣ³+hₓ₁xᵣ²yᵣ+iₓ₁xᵣyᵣ²+jₓ₁yᵣ³+ . . .
yᵣₛ=a_{y1}+b_{y1}xᵣ+c_{y1}yᵣ+d_{y1}xᵣ²+e_{y1}xᵣyᵣ+f_{y1}yᵣ²+g_{y1}xᵣ³+h_{y1}xᵣ²yᵣ+i_{y1}xᵣyᵣ²+j_{y1}yᵣ³+ . . .
where (xᵣ, yᵣ) is a design position of the original plate, (xᵣₛ, yᵣₛ) is a real position of the original plate, and aₓ₁˜jₓ₁ and a_{y1}˜j_{y1} are predetermined coefficients.

5. A device manufacturing method comprising the steps of:
exposing a substrate using an exposure apparatus; and
developing the exposed substrate,
wherein the exposure apparatus is configured to expose a pattern of an original plate onto the substrate, the exposure apparatus comprising:
an original plate alignment detector configured to move the original plate in an in-plane direction at an outside of an exposure region to measure positions of a plurality of alignment marks of the original plate;
a measurement unit configured to measure a position of the original plate alignment detector;
a calculator configured to calculate a position and a shape of the original plate from the positions of the plurality of alignment marks; and
a correction unit configured to perform a correction in accordance with the position and the shape of the original plate during exposure.
